(19) United States
(12) Patent Application Publication
(10) Pub. No.: US 2024/0251900 A1
(43) Pub. Date: Aug. 1, 2024

(54) PATCH FOR TARGETED DELIVERY OF HAIR COMPOSITION AND METHOD FOR APPLYING SAME

(71) Applicant: Better Not Younger Corporation, Miami, FL (US)

(72) Inventors: Sonsoles Gonzalez, Miami, FL (US); Debra Lin, Oakland, CA (US)

(73) Assignee: Better Not Younger Corporation, Miami, FL (US)

(21) Appl. No.: 18/401,333

(22) Filed: Dec. 29, 2023

Related U.S. Application Data
(60) Provisional application No. 63/477,704, filed on Dec. 29, 2022.

(51) Int. Cl. A41G 5/00

(52) U.S. Cl. CPC A41G 5/008

(57) ABSTRACT

A patch formed into a suitable shape to fit an area of thinning hair to enable targeted delivery of a composition comprising hair-stimulating ingredients. The patch comprises a mesh substrate and hydrogel system which includes active ingredients that promote the improvement of hair growth and strength in targeted areas experiencing hair thinning.

### RELATED APPLICATIONS

This application claims priority to U.S. Application Ser. No. 63/477,706, filed Dec. 29, 2022, the entirety of which is incorporated herein by reference.

### FIELD OF THE INVENTION

The present disclosure relates to the use of a patch to apply a composition to the skin and hairline area to address the appearance of hair thinning and loss.

### BACKGROUND

Hair thinning and hair loss (commonly known as alopecia) is observed in both males and females of all ages. In particular, hair loss and thinning is most commonly associated with the aging process and is associated with a decrease in self-esteem and self-confidence. Widely known and studied within males, female pattern hair loss (FPHL) has had to rely on research and products developed to address the causes of male pattern baldness. Studies of hair loss among women have identified its prevalence across countries along with an increase in hair loss and thinning following menopause.

The hair follicle is the root of hair development and growth. Within the follicle is dermal papilla and keratinocytes. The dermal papilla provides nutrients and oxygen to the follicle through the vasculature and also plays a crucial role in the dermal-epidermal interactions. Keratinocytes produce the protein keratin which accumulates within the follicle to form the shaft of the hair. The thickness of the hair shaft is determined by the size of the hair follicle.

Normal hair growth contains three phases: anagen, catagen, and telogen. The anagen phase is the longest lasting somewhere between 2 and 6 years in which the hair is actively growing about 3-4 mm a day. The catagen phase follows, lasting about 2-3 weeks, in which the root detaches from the dermal papilla and stops growing. During the catagen phase the hair follicle shrinks and migrates toward the scalp. During the telogen phase the hair remains attached to the scalp for 3-4 months before falling out. The hair follicle starts to regenerate and migrate down to the bottom of the epidermis. Following the telogen phase, the hair follicle re-enters the anagen phase and the next hair begins to form.

The start of any new hair cycle requires the regeneration of the hair follicle which is dependent on hair follicle stem cell (HFSC) activity. HFSCs are multipotent progenitor cells capable of differentiating into any of the functional cells of the hair follicle matrix. During the telogen phase the HFSCs remain dormant but in the reservoir membrane anchored by collagen. When the anagen phase begins, the dermal papilla sends signals to HFSCs to begin differentiation and for undifferentiated keratinocytes to proliferate rapidly and migrate to the bottom of the hair follicle to begin the accumulation of the hair shaft.

Causes of hair thinning and loss are not completely understood. However, the shortening of the anagen phase along with a miniaturization of the hair follicle are hallmark signs of the beginning of hair thinning and loss.

Hair thinning often has (and can be a result of) a number of factors including: genetics (e.g., androgenic alopecia), aging, nutritional deficiencies (e.g., essential fatty acids, zinc, iron, vitamin D, protein), endocrine disorders, hormonal changes (e.g., androgens such as dihydrotestosterone, pregnancy, childbirth, menopause), stress (e.g., emotional, physical, hair styling, hairstyles), medical conditions (e.g., hypothyroidism, hyperthyroidism, cancer, type 2 diabetes, inflammation), medications, drug side effects, medical procedures (e.g., surgery, chemotherapy, radiation therapy), allergic reactions, infections (e.g., bacteria, virus, fungus, herpes zoster, ringworm, HIV, AIDS, syphilis, leprosy, staph A), autoimmune diseases (e.g., alopecia areata, lupus, sarcoidosis, scleroderma), skin conditions (e.g., psoriasis, rosacea, eczema, contact dermatitis, seborrheic dermatitis, blepharitis), environmental factors (e.g., sun exposure, sunscreens, pollutants (e.g., dioxins) in food made from animals), or other lifestyle factors.

Androgens are a class of hormones that have been associated with hair loss. More specifically, the androgen testosterone and its metabolic product dihydrotestosterone (DHT) is associated with hair loss. DHT is formed through the actions of an enzyme, 5-α-reductase, which have two types type I and II. Females are affected by another enzyme, aromatase, which converts testosterone to estradiol.

Microinflammation is a term that has been used to describe a mild to moderate lymphohistiocytic inflammatory infiltrate that accompanies the miniaturization of the hair follicle during the balding process. This chronic inflammation is slow, subtle, and painless but is considered to contribute to hair thinning and loss and is thought to be caused by external factors including heat, friction, UV radiation, and microflora.

The primary area on the body for hair thinning, hair loss, a receding hairline, and balding is the scalp: the skin covering the head, excluding the face. For instance, spot baldness can affect both men and women; it can result in one or more bald spots on the scalp, each about the size of a coin. Men and women can also experience hair thinning and loss on parts of the body beyond the scalp, such as face, eyebrows (superciliary madarosis), eyelashes (ciliary madarosis), facial hair like a mustache or beard (alopecia barbae), pubic region, underarms, arms, and legs (anterolateral leg alopecia).

In both males and females, the hair follicle changes that lead to hair thinning are similar (androgenic alopecia). However, the patterns observed indicate the physiological process differs between males and females. In males with male patterned hair loss (MPHL) on the scalp, a distinct pattern of hair thinning starts at the crown and progresses to a deepening M-shaped pattern along the hair lines, receding sharply and possibly leading to baldness. In women with female patterned hair loss (FPHL) on the scalp, the observed pattern is characterized more by the thinning of the hair in certain areas including the hair part and bitemporal and biparietal regions (frontal fibrosing alopecia). FPHL rarely leads to complete baldness.

The frequency of FPHL varies between populations but increases with age overall. The demand for treatment of FPHL begins between 25-40 years old with a second peak occurring around the onset of menopause (50-60 years). The loss of hair does not bring a serious threat to female physiological health but can present issues of self-esteem and exacerbate psychological issues.

Current existing treatments for FPHL are modified therapies originally developed to treat MPHL. These treatments include minoxidil, finasteride, and other additive products aimed at addressing hair thinning including additives to shampoos and conditioners.

Minoxidil, the active component of Rogain™, is the most commonly used topical agent to address both MPHL and FPHL. While minoxidil has had better success than others on the market, the success rate for FPHL still lags behind the results of MPHL (Manabe et al., Journal of Dermatology 2018; 45: 1031-1043). Additionally, minoxidil has reported adverse events including itching, erythema, desquamation, folliculitis, contact dermatitis and facial hirsutism.

Finasteride, the active component of Propecia™, is an oral agent that has proven successful for MPHL. However, its use in females has been contraindicated.

Other products on the market aimed to improve FPHL exist in the form of shampoos and conditioners or additives for shampoos and conditioners and nutrient supplements. These products rely on products originally created to address MPHL but have been rebranded to address FPHL. Additionally, they fail to provide a targeted response to the typical pattern of FPHL. The market lacks an adequate product that is designed to address the unique presentation of FPHL.

### SUMMARY

The present disclosure is generally related to a composition that can be used to reduce the appearance of hair thinning and loss, and more particularly related to a patch for targeted delivery of such a hair composition. In some aspects, a composition designed for females to support fuller-looking hair. In some aspects the disclosure is related to a composition within a mesh-hydrogel patch that allows for sustained release of active ingredients to a targeted area of hair thinning and loss. In some aspects the disclosure is used to reduce the appearance of hair thinning and loss specifically in the temple region of the forehead. In other aspects the disclosure is used to reduce the appearance of hair thinning and loss on the parietal area of the scalp. In other aspects, the disclosure is used to reduce the appearance of hair thinning and loss in affected areas on the scalp.

The composition includes a component for promoting hair stimulation, a component for activating the hair follicle, and a component for calming the skin. The composition is included in a hydrogel layer of a patch with a mesh substrate. The hydrogel layer provides a basis for a sustained-release of the active ingredients into the affected skin/hair area. The mesh substrate provides flexible structural support to the delicate hydrogel/composition layer for optimal application. The patch is capable of being adhesively applied to a location on the body which includes both hair and skin.

### BRIEF DESCRIPTION OF THE DRAWINGS

The drawings and detailed description that follow are intended to be merely illustrative and are not intended to limit the scope of the disclosure as contemplated by the inventors. The detailed description of specific embodiments can be best understood when read in conjunction with the following drawings.

Unless otherwise specifically noted, articles depicted in the drawings are not necessarily drawn to scale.

FIGS. 1A-1M display various embodiments of patch shapes.

FIG. 2 shows one embodiment of a mesh substrate.

FIG. 3A shows hair thinning at a user's temple.

FIG. 3B shows an exemplary patch delivering a hair composition to the targeted location shown in FIG. 3A.

FIGS. 4A-4E show a representation of the normal growth cycle of hair.

FIGS. 5A-5C show the results of customer testing with the product.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of steps performed in the execution of a method does not imply that those steps must be performed in the order presented but instead may be performed in a different order or in parallel.

The present disclosure is related to a composition that can be used to reduce the appearance of hair thinning through a targeted delivery of a sustained-release composition comprising one or more active ingredients In some aspects the disclosure is used to reduce the appearance of hair thinning and loss, specifically in the temple region of the forehead. In other aspects, the disclosure is used to reduce the appearance of hair thinning and loss on the parietal area of the scalp. In other aspects, the disclosure is used to reduce the appearance of hair thinning and loss in affected areas on the scalp.

In one embodiment, the composition includes three key ingredients.

The first ingredient is for hair stimulation. This ingredient is intended to provide one or more of the following benefits: densifying hair, thickening hair, promoting hair stimulation, boosting hair stimulation, improving hair anchorage, reducing inflammation, encouraging longer time in hair growth phase of hair cycle, encouraging hair cell activity, stimulating the hair follicle regeneration process, or reducing the hair follicle miniaturization process. In one embodiment, the ingredient is Capixyl™ which is composed of a biomimetic compound (Acetyl Tetrapeptide-3) and a red clover flower (Trifolium Pratense) extract rich in Biochanin A. Alternately, similar benefits can be provided from one or more of the following ingredients: Widelash™ (panthenol, Biotinoyl Tripeptide-1), Procapil™ (PEG-40 Hydrogenated Castor Oil, Apigenin, Oleanolic Acid, Biotinoly Tripeptide-1), Anagain™ (Pisum Sativum (Pea) sprout extract), copper tripeptide, peptides, rosemary, and watercress.

The second ingredient is for scalp calming. This ingredient is intended to provide one or more of the following benefits: soothing, nourishing, moisturizing, cooling, reducing redness and reducing the impact of inflammation. In one embodiment the cooling ingredient is something other than camphor-like plant based ingredients including menthol, peppermint, eucalyptus, mint, or cooling sensate ingredients including cinnimal, vanillin, and capsacin. In one embodiment, the ingredient for scalp calming is Centella asiatica. Alternately, similar benefits can be provided by one or more of the following: aloe, massodecaside, Houttuynia cordata, and chamomile.

The third ingredient is for hair follicle activation. This ingredient is intended to provide one or more of the following benefits: antioxidant defense, cell promotion, hair strengthening, DHT inhibition, and aromatase modulation. In one embodiment the ingredient that activates hair follicles is something other than ginger which can have hair stimulation effects and DHT inhibition but also inhibit other unrelated cellular activities. In one embodiment, the ingredient for hair follicle activation is red ginseng collagen. Alternately, similar benefits can be provided by one or more of the following: Panax Ginseng, licorice, Scutellaria baicalensis root extract, green tea extract, and onion extract.

In one embodiment, the composition includes a component that is capable of promoting hair stimulation, a component that is capable of enhancing hair strength, and a component that is capable of promoting healthy skin conditioning. In another embodiment, the composition further includes a solvent and a humectant. In one embodiment, the composition includes an antifungal medication such as ketoconazole.

In one embodiment, the composition is included in a hydrogel layer which is incorporated into an adhesive patch delivery system which can be applied to the body.

Hydrogel patches typically include an inert, impervious backing layer, an adhesive layer containing a polymer base and a composition, and a release liner that is peeled off and discarded before applying the patch to the skin. Suitable backing layers comprise one or more components selected from the group consisting of: woven synthetic fibers, a mesh size that is capable of ensuring flexibility for the patch itself but providing enough support to the hydrogel layer and materials and material that does not attract active ingredients in the hydrogel. In one embodiment, the backing layer is a woven nylon with a mesh size of at least 0.025 mm×0.025 mm. In another embodiment, the backing layer is a woven nylon with a mesh size of no greater than 1 mm×1 mm. In one embodiment, there is no backing layer. In one embodiment, there is no release liner.

Polymer bases may be natural or synthetic in origin. Suitable polymer bases comprise one or more ingredients selected from the group consisting of: polyvinyl alcohol and polyvinyl pyrrolidone, maleic anhydride/vinyl ether copolymer, gelatin, alginate, heparin, chitosan, fibrin, hyaluronic acid, hydroxyethyl methacrylate, cargeenane, hydroxyethyl cellulose, acrylate, agar, hydroxypropyl cellulose, hydroxypropylmethyl cellulose, methyl cellulose, carboxyvinyl copolymer, polyethylene oxide, polyethylene glycol, polyacryl amide, polyhydroxyethyl methacrylate, polydioxolane, polyacrylic acid, polyacryl acetate, polyacryl amide, polyvinyl chloride, and combinations thereof. In one embodiment, the polymer base is a natural-origin polymer selected from the group such as gelatin, heparin, chitosan, fibrin, alginate, hyaluronic acid, and combinations thereof. In one embodiment, the polymer base is polyacrylate, carrageenan, and carob gum. In another embodiment, the polymer is composed of 0.05-0.15% polyacrylate, 0.1-0.5% carrageenan, and 0.3-0.6% carob gum. The composition is directly incorporated into the hydrophilic polymer solution and then mixed to give a hydrogel composition containing the composition. The hydrogel/composition mixture is then delivered onto the mesh substrate where the mesh becomes embedded in the hydrogel/composition mixture as it solidifies into a gel.

The patch is applied to an area of hair thinning and loss. The patch is designed to fit easily on a hairline area and is capable of adhering to both hair and skin. The patch may take many shapes to address different body parts. The patch may be designed as a boomerang or gumdrop to apply to the temple regions of the forehead. The patch may be designed as a strip to fit along the hairline or on eyebrows in areas experiencing thinning and hair loss. The patch may be designed as a round spot to fit on to a round spot of hair thinning and loss on the scalp. The patch may be designed as sheets for the user to cut and shape into their own design. The patch allows for the active ingredient that promotes hair growth, the active ingredient that enhances hair strength, and the active ingredient that promotes healthy skin conditioning to be in contact with the skin area that is affected by hair thinning and loss.

In another embodiment, the present disclosure relates to a method for increasing the appearance of hair growth by applying the adhesive patch to an area affected by hair thinning and/or loss. The adhesive patch is then used to contact the skin with the hydrogel substrate containing the composition discussed above.

### Patch

The patch combines a mesh substrate with a hydrogel composition that contains the active ingredients. The patches are displayed in different arrangements allowing for different placement in areas prone to hair thinning and loss. Each patch contains an anterior mesh substrate side and a posterior hydrogel side including the active ingredients. The mesh substrate provides structure and a protective barrier for the hydrogel from the outside environment including evaporation or disintegration of the active ingredients. The mesh substrate results in allowing an isolated environment for the hydrogel to interact with the affected area. The hydrogel mixture is designed to allow for ease of active ingredients to be absorbed into the skin of the affected area.

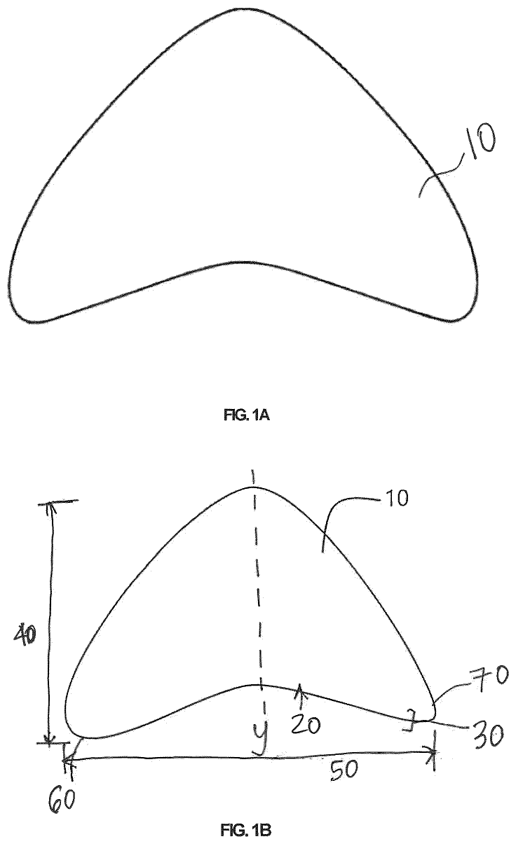

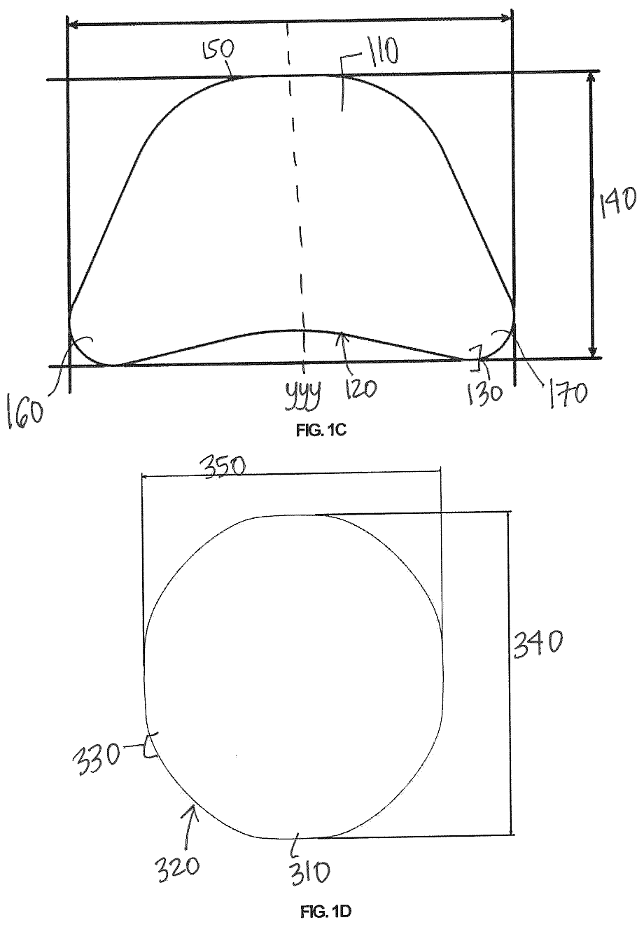

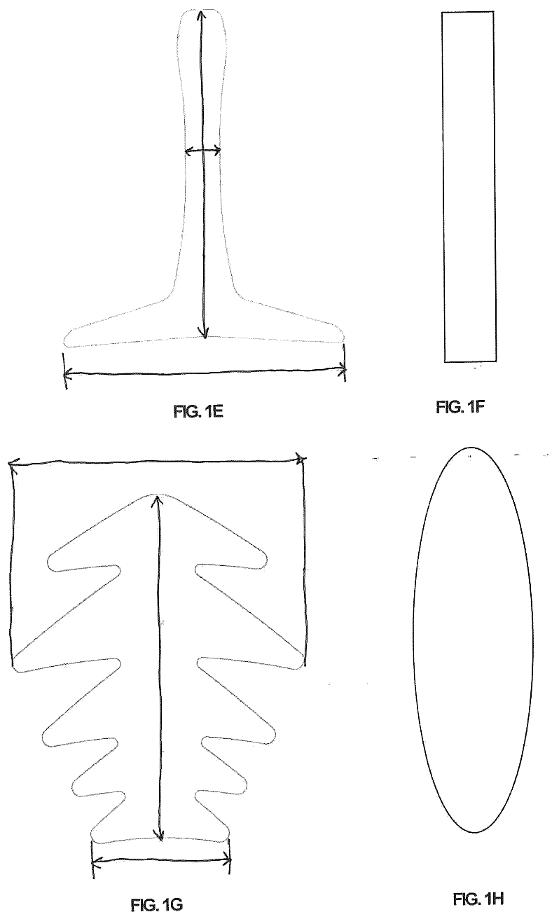

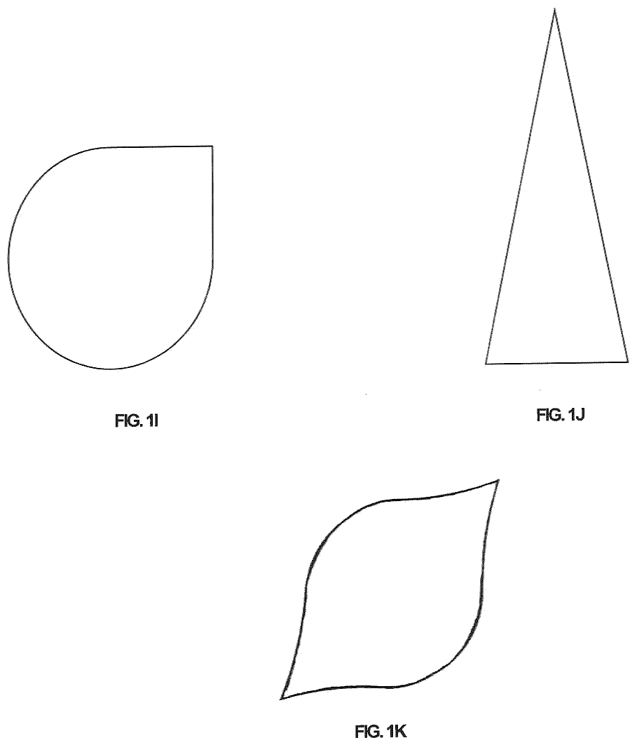

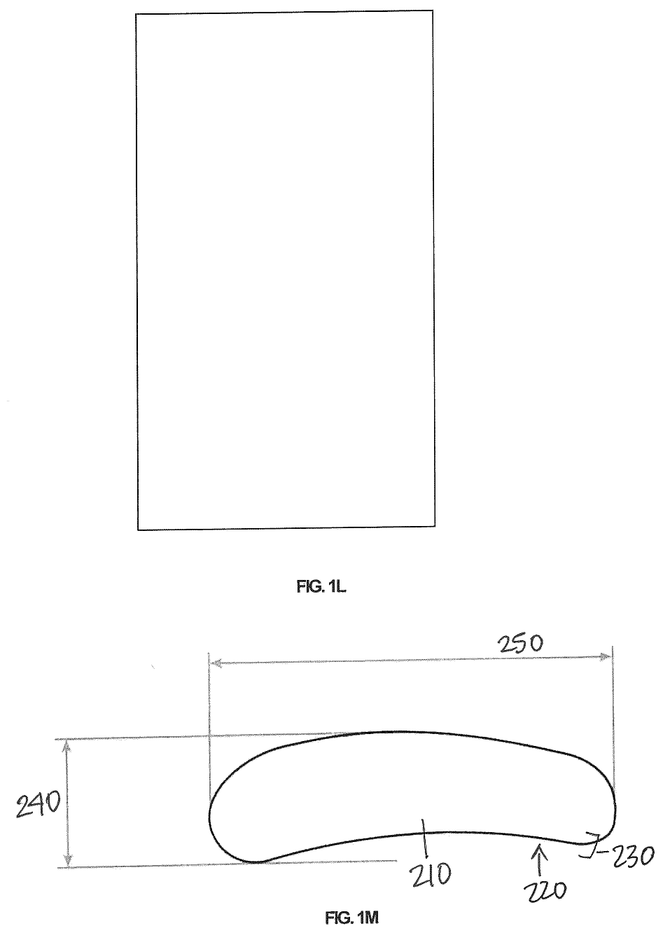

FIG. 1A displays a first patch design that fits over the temple region along a female hairline. It is generally boomerang-shaped. The patch comprises a mesh substrate side 10a opposite a hydrogel side 20a. The patch can be generally symmetrical about axis y, or the patch may be asymmetrical about axis y. In the embodiment shown, the patch is asymmetrical about axis y: first end 60a has a wider radius than second end 70a. In one embodiment, the patch has a height 40a of 4.5 cm with a length 50a of 6.5 cm and a thickness 30a of 0.1-3 mm.

FIG. 1B displays a second patch design that fits over the temple region along a female hairline. It is generally boomerang-shaped. The patch comprises a mesh substrate side 10b opposite a hydrogel side 20b. The patch is asymmetrical about axis yy: first end 60b has a wider radius than second end 70b. In one embodiment, the patch has a height 40b of 4.5 cm with a length 50b of 6.5 cm and a thickness 30b of 0.1-3 mm.

FIG. 1C displays a patch designed to fit over a male hairline. It is generally gumdrop-shaped. The patch comprises a mesh substrate side 110 opposite a hydrogel side 120. The patch is symmetrical about axis yyy: first end 160 has the same radius as second end 170. In one embodiment, the patch has a height 140 of 5 cm and a length 150 of 7 cm with a thickness 130 of 0.1-3 mm.

FIG. 1D displays a patch design that can be used on the crown of either a male or female. The patch comprises a mesh substrate side 210a opposite a hydrogel side 220a. In one embodiment, the patch of FIG. 1D has a height 240a of 12 cm and a length 250a of 11 cm with a thickness 230a of 0.1-3 mm. In other embodiments, the patch may be smaller—such as coin-sized—to address spot baldness, or the patch may be larger—such as hat-sized—to address substantially the entire crown (top and back of scalp). In another embodiment, the patch may be 20 cm in diameter to address a large crown spot.

FIG. 1E displays a first patch design that can be used on the part line of a male or female. It is generally shaped like an upside-down T, with a longer portion and a shorter portion. The longer portion is intended to cover a hair part line, and the shorter portion is intended to cover a hairline. The patch comprises a mesh substrate side 210b opposite a hydrogel side 220b.

FIG. 1F displays a second patch design that can be used on the part line of a male or female. It is generally rectangle-shaped. The patch comprises a mesh substrate side 210b opposite a hydrogel side 220b. In one embodiment, the patch 220b has a height 240b of 6 cm and a length 250b of 15 cm with a thickness 230b of 0.1-3 mm.

FIG. 1G displays a third patch design that can be used on the part line of a male or female. It is generally tree-shaped and can address “Christmas-tree”-shaped hair thinning. The patch comprises a mesh substrate side 210b opposite a hydrogel side 220b. In one embodiment, the patch 220b has a height 240b of 2 cm and a length 250b of 5 cm with a thickness 230b of 0.1-3 mm.

FIG. 1H displays a fourth patch design that can be used on the part line of a male or female. It is generally oval. The patch comprises a mesh substrate side 210b opposite a hydrogel side 220b. In one embodiment, the patch 220b has a height 240b of 6 cm and a length 250b of 15 cm with a thickness 230b of 0.1-3 mm.

FIGS. 1I-1L display additional patch shapes.

FIG. 1M displays a patch design that can be used on the eyebrow region of a male or female. The patch comprises a mesh substrate side 310 opposite a hydrogel side 320. In one embodiment, the patch 320 has a height 340 of 2 cm and a length 350 of 5 cm with a thickness 330 of 0.1-3 mm.

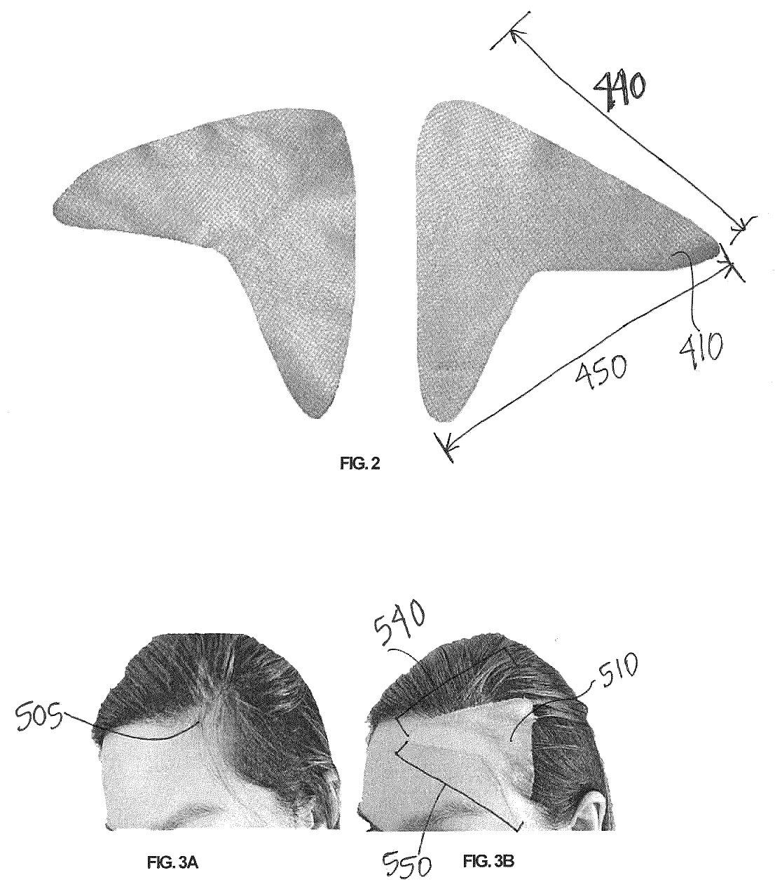

FIG. 2 displays one embodiment of a patch having a mesh substrate side 410 opposite a hydrogel side 420. The height of the patch is represented by 440 and the length of the patch is represented by 450. The thickness of the patch is 0.1-3 mm.

The placement of the patch in an area affected by hair thinning and/or loss is displayed in FIGS. 3A and 3B. FIG. 3A displays an example of an affected area of hair thinning at the temple region represented by 505. FIG. 3B displays the proper application of the patch to the affected area 505. The mesh substrate 510 faces the anterior side of the application and the height 540 covering both the skin and the hairline area and the length 550 spans the portion of the area affected by the hair thinning and loss.

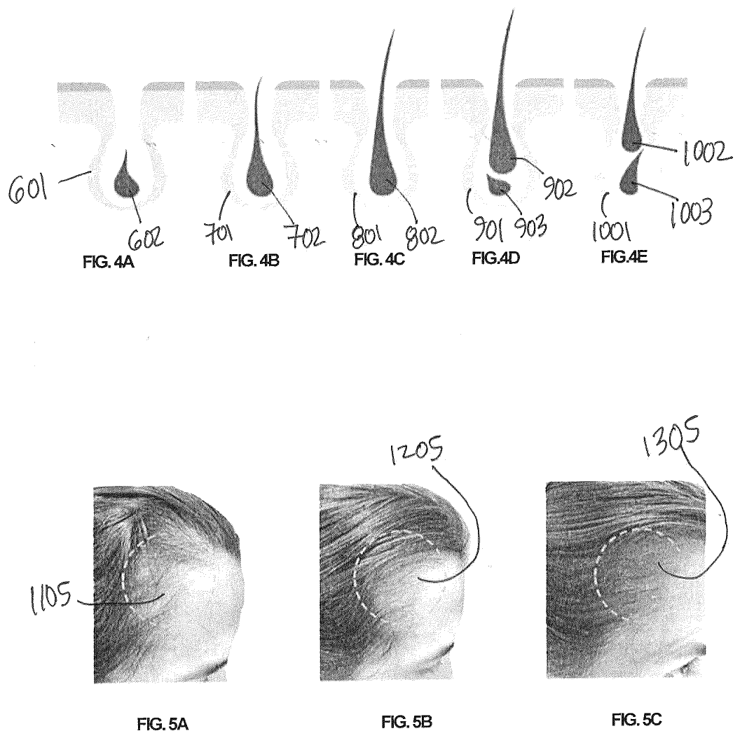

FIG. 4 represent the normal life cycle of a growing hair. FIG. 4A represents the anagen phase which lasts from 2-7 years and represents 80-90% of the hair on a typical adult head. In this phase the hair follicle 601 pushes out hair 602 that continues to grow until it is cut or naturally shed. FIG. 4B represents the catagen phase which lasts for a few weeks and represents about 5% of the hair on a typical adult head. In this phase the hair follicle 701 shrinks and growth slows and the hair shaft 702 separates from the hair follicle but stays in place. FIGS. 4C and 4D represent the telogen phase which typically lasts around 3 months and represents about 10-15% of the hair on a typical adult head. FIG. 4C specifically represents early in the phase when the hair follicle 801 stops active growth of the hair shaft 802 but does not fall out. FIG. 4D represents late telogen phase where the detached hair shaft 902 begins to be pushed out by a new growing hair 903 in the hair follicle 901 in the anagen phase. FIG. 4E represents the exogen phase, or the shedding phase where the new hair shaft 1003 in the hair follicle 1001 pushes the old hair shaft 1002 to the point it releases from the scalp and is shed. This phase typically lasts 2-5 months. A normal healthy adult will typically lose about 50-100 hairs per day.

Results from continuous, regular use of the patch in an affected area is demonstrated by FIGS. 5A-C. FIG. 5A demonstrates improved growth observed at 1-2 months with continuous use of product. Note the presence of new growth and baby hairs in the area of 1105. FIG. 5B demonstrates the improved growth observed at 2-3 months with continuous use of product. Note the presence of stronger looking hair along with less shedding or baby hairs in the area of 1205. FIG. 5C demonstrates the improved growth observed following more than 3 months of continuous use of product. Note denser, thicker-looking hair and less visible scalp at the area of 1305.

A normal hair growth cycle contains four phases: anagen (growing), catagen (transition), telogen (resting), and exogen (shedding). The anagen phase is the longest phase, lasting somewhere between 2 and 6 years, during which the hair is actively growing about 3-4 mm a day. The catagen phase follows, lasting from about 10 days to about 3 weeks, in which the root detaches from the dermal papilla and stops growing. During the catagen phase the hair follicle shrinks and migrates toward the scalp. During the telogen phase the hair remains attached to the scalp for 3-4 months before falling out. The hair follicle starts to regenerate and migrate down to the bottom of the epidermis. Following the telogen phase, the hair follicle re-enters the anagen phase and the next hair begins to form.

The start of any new hair cycle requires the regeneration of the hair follicle which is dependent on hair follicle stem cell (HFSC) activity. HFSCs are multipotent progenitor cells capable of differentiating into any of the functional cells of the hair follicle matrix. During the telogen phase the HFSCs remain dormant but in the reservoir membrane anchored by collagen. When the anagen phase begins, the dermal papilla sends signals to HFSCs to begin differentiation and for undifferentiated keratinocytes to proliferate rapidly and migrate to the bottom of the hair follicle to begin the accumulation of the hair shaft.

Causes of hair thinning and loss are not completely understood. However, the shortening of the anagen phase along with a miniaturization of the hair follicle are hallmark signs of the beginning of hair thinning and loss.

### Compositions

In one embodiment, the hair supporting ingredients/serum include one or more of the following: Capixyl™ (ingredient blend from Lucas Meyer Ingredient Supplier (Acetyl Tetrapeptide-3, Trifolium Pratense (Clover) Flower Extact), Ginseng, Centella ssiatica, Hyaluronic Acid, and the like. Other ingredients are also suitable and may be further include or substituted for one or more of the above-ingredients including: Procapil™, Widelash™, AnaGain™ or other chemical compositions that contain hair boosting, hair growth promoting, thickening ingredients. Vegamour GRO Hair Serum—liquid serum contains Capixl from Lucas Meyer Cosmetics. Better Not Younger Fortifying Hair & Scalp Serum—Procapil™, Centella asiatica, Ginger, Kelp, Niacinamide. Nutrafol Growth Activator Hair Serum—Ashwagandha, Pea Sprout, Green Tea, Sea Buckthorn.

In one embodiment, the hydrogel/mesh hybrid 10 comprises a gel system and a mesh substrate. The gel system comprises polyacrylate (0.05%-0.15%)—Carrageenan (0.1-0.5%)—Carob Gum (0.3-0.6%) gelling system. This is a relatively soft and low strength hydrogel compared to other substrates such as a bio-celluose film or the firmer hydrogels used for skin which has a smaller polymer chain entanglement. Furthermore this gel does not demand complete skin adhesion to be retained in place. In one embodiment, the mesh substrate comprises a woven nylon-6 fiber with a mesh size of about 0.025 mm×0.025 mm to 1 mm×1 mm. The substrate mesh size is an important parameter to ensure flexibility of the hydrogel/mesh substrate while providing the support for the hydrogel. The mesh size needs to be large enough to allow for flexibility to be set against skin and hair but small enough to provide the structural support.

In one embodiment, ranges and ingredients for the components of the invention are as follows: hydrogel thickness—0.1 mm-3 mm; gel hydration water content—55%-96%; analogous actives promoting hair thickening comprise one or more of: Procapil™, Widelash™, Anagain™, Copper Tripeptide, peptides, Rosemary, Watercress; and supporting extracts comprise one or more of: Red Ginseng collagen, Panax ginseng, Licorice, Scutellaria baicalensis root extract, green tea extract, onion extract Centella asiatica, Aloe, massodecaside, Houttuynia cordata, Chamomile.

In one embodiment, the composition includes an ingredient to promote hair stimulation, an ingredient to activate the hair follicle, and an ingredient for skin calming.

In one embodiment, the ingredient to promote hair stimulation is Capixyl™. The ingredient to promote hair stimulation could also include Procapil™, AnaGain™, Widelash™, Copper Tripeptide, Peptides, Rosemary, or Watercress. In one embodiment, the ingredient for activating the hair follicle is red ginseng. The ingredient for activating the hair follicle may also include Panax ginseng, licorice, Scutellaria baicalensis root extract, green tea extract, and onion extract. In one embodiment, the ingredient for skin calming is Centella asiatica. The ingredient for skin calming may also be sodium hyaluronate, Chondrus crispus extract, sucrose, glycerin, aloe, massadecaside, Houttuynia cordata, or chamomile. In one embodiment, the composition comprises 1-4% Capixyl™, at least 1% red ginseng extract, and at least 1% Centella asiatica.

Capixyl™ is a composition capable of preventing and reducing the hair loss process through the combination of a biomimetic peptide, acetyl tetrapeptide-3, and a red clover extract, trifolium pretense. It is produced by Lucas Meyer Cosmetics. Cosmetic properties of Capixyl™ include preserving hair follicle stem cell (HFSC) activity, improving Collagen XVII synthesis to maintain healthy HFSC. Improving hair follicle regeneration, improving extracellular matrix (ECM) protein renewal for optimal hair follicle anchoring, reducing IL-8 pro-inflammatory cytokine to reduce microinflammation, and reducing 5-α-reductase enzyme activity.

One of the active ingredients of Capixyl™, acetyl tetrapeptide-3 is a biomimetic peptide derived from a signal peptide that has potent tissue protective properties and stimulates tissue remodeling after the initial phase of wound healing. It has been shown to directly affect the hair follicle by stimulating collagen production to assist in improving the extracellular matrix (ECM) proteins. Additionally, it has been shown to stimulate hair growth better than the market reference, Minoxidil (Capixyl techsheet page 38). Acetyl tetrapeptide-3 acts as a signaling molecule to increase the hair follicle and improve hair anchoring.

The other active ingredient in Capixyl, red clover (Trifolium Pretense) flower extract is a natural compound found throughout central and Northern Europe and Asia. Traditionally, it has been used to treat asthma, cancer, gout, and various inflammatory disorders. Red clover contains Biochanin-A which is known to be an effective inhibitor of 5-α-reductase type I and II activity. Research has also indicated Biochanin-A may modulate chronic inflammation and act as an antioxidant, limiting free radical damage to the skin and scalp.

Capixyl™'s efficacy is based on the combined effects of its two active ingredients. By directly blocking DHT and modulating the micro-inflammatory process, Capixyl™ acts to restore normal hair cycle, prevent hair follicle miniaturization, and improve ECM proteins. This leads to an increase in follicle size and better anchoring for hair papilla, which eventually leads to reduced hair loss, stimulation and boost of hair growth.

Procapil™ is a composition produced by Sederma that is active when present at 1-3% of the composition. The main active ingredients of Procapil™ are vitaminated matrikine with apigenin and oleanic acid from aging olive tree leaves. More specifically, Oleanolic acid inhibits 5-α-reductase, apigenin improves micro-circulation and biotinoyl-GHK stimulates cell metabolism. These ingredients work together to promote hair anchoring by strengthening the hair follicle metabolism and structure. Clinical Studies observed benefits to both female and male populations.

AnaGain™ is a composition produced by Mibelle AG Biochemistry that is active when present at 1-4% of the composition. AnaGain™ is from pea sprouts and works to stimulate signal molecules in the dermal papilla that in turn stimulate hair growth. Benefits of AnaGain™ include stimulating hair growth at the root, prolonging the life cycle of the hair, restoring the vitality of the hair, and producing denser hair in 3 months. It has also been proven to be useful in both men and women.

Widelash™ is a composition produced by Sederma that is active at 2% concentration. The active ingredients include vitaminated matrikine, biotinoyl-Gly-His-Lys, and provitamin B5 (panthenol). Benefits of using Widelash™ include promoting hair bulb keratinocyte proliferation, ensuring hair anchorage by stimulating the synthesis and organization of the adhesion molecules laminin 5 and collagen IV. The main application of Widelash™ has been as an add-in for mascara and eyelash products. In embodiments that are intended to be used to address eyebrow concerns, this ingredient may be preferable.

In one embodiment, the agent that is capable of enhancing hair strength is red ginseng collagen. Korean ginseng (Panax ginseng Meyer) is a plant native to east Asia. Red Ginseng has been shown to promote hair growth and improve skin health without any observed adverse effects. Linoleic acid and β-sitosterol are believed to be the active components in red ginseng. These two components have been observed to increase expression of Wnt/β-catenin and Shh/Gli pathway-associated proteins that are required for the promotion of hair growth and inhibit 5-α-reductase activity, leading to the enhancement of hair regeneration.

In one embodiment, the agent that is capable of promoting healthy skin conditioning is Centella asiatica (CA). CA is a plant found mostly in Asia. CA has been indicated as a treatment for disorders affecting the neurological, endocrine, skin, cardiovascular, digestive, respiratory, and gynecological systems. The active ingredient in CA are the triterpenes, including asiaticoside, asiatic acid, madecassoside, and madecassic acid. The triterpenoids have been known to display antioxidant properties by increasing the activity of superoxide dismutase and glutathione peroxidase and reducing the production of reactive oxygen species. The triterpenes are also believed to have anti-inflammatory effect showing a decreased expression of TNF-α, IL-1β, IL-8, IL-4, and IL-13 as well as a local anti-inflammatory response with decreased IgE. CA extract has also been associated with inhibition of hyperkeratosis, mast cell, and inflammatory cell infiltration. CA has also been associated with wound healing, with special observations for promoting fibroblast and collagen formation. CA has also been observed to have a positive effect on dermal papilla cells and increased expression of characteristic genes related to hair growth in the cells.

In one embodiment, the patch is 0.1 mm thick. The thickness of the patch affects its adhesive quality of the hydrogel. In one embodiment, patches intended to be applied to a more vertical area, such as the temple region of the forehead, may be 0.1 mm thick. A vertically applied patch needs to rely more on the adhesive quality of the patch which would make it preferable to be 0.1 mm. In another embodiment, the patch is 0.3 mm thick. In one embodiment, patches intended to be applied to more horizontal areas, such as the crown of the head, may be 0.3 mm thick. A horizontally applied patch may need less of the adhesive qualities of the patch allowing them to be thicker. A patch may be thicker due to increased concentrations of active ingredients allowing more active ingredients to be absorbed into the skin and hair area.

This formula working together addresses the main issues affecting FPHL. Multiple ingredients address DHT blocking by inhibiting both type I and II 5-α-reductase, microinflammation, and strengthening the dermal papilla through collagen and other supportive proteins. Additionally, the formula provides anti-oxidant factors and dermal support to improve skin health at the same time as promoting the hair follicle development. The formula provides factors to feed the microenvironment through a process that addresses the needs of the hair follicle while retaining the health of the surrounding dermal skin layer.

### Method of Use

In another embodiment, the present disclosure relates to a method for increasing the appearance of hair growth by applying the adhesive patch to an area affected by hair thinning and/or loss. The adhesive patch is then used to contact the skin with the hydrogel substrate containing the composition discussed above.

In one embodiment, the patch contacts the skin and/or hair for at least about 2 minutes, at least about 5 minutes, at least about 10 minutes, at least about 15 minutes, or at least about 20 minutes. After the appropriate amount of time, the patch may be removed. This process is repeated at least every other day for at least about 1 week, at least about 2 weeks, at least about 3 weeks, at least about 4 weeks, at least about 6 weeks, or at least about 8 weeks.

In another embodiment, the patch contacts the skin and/or hair for at least 15 minutes. After the appropriate amount of time, the patch may be removed. This process is repeated at least every other day for at least 12 weeks.

In another embodiment, the patch contacts the skin for at least 10 minutes. After the appropriate amount of time, the patch may be removed. This process is repeated once a day for at least 8 weeks.

In another embodiment, the patch contacts the skin for at least 15 minutes. After the appropriate amount of time, the patch may be removed. This process is repeated once a day for at least 12 weeks.

In another embodiment, once the patch is removed excess hydrogel is used in additional spots of hair and skin. The additional gel may be left on for at least 10 minutes. Additionally, a separate material may be applied to protect the area from air exposure.

In another embodiment, the patch continues to be applied following the first 8-12 weeks of use. The match may be applied for at least 10-15 minutes. The patch may be used on a daily or every other daily frequency.

### Alternative Delivery Systems

Rather than in patch form, the active ingredient composition could be included in one or more of the following: a cream, ointment, oil, gel, foam, shampoo, conditioner, solution, lotion, spray, leave-in treatment, or other topical agent.

### Alternative Delivery Methods

The topical agent could be applied and allowed to absorb through the skin and/or into the hair with the skin and/or hair open to the air. The wearer could also cover the area with a bandage, wrap, headband, or material of concealment of their own.

### EXEMPLIFICATION

### Example 1: Concentrated Hair Densifying Patches for Targeted Delivery

The hydrogel-mesh patch is contained within an airtight sealed plastic pouch. The pouch contains two notches at the top for ease in tearing open without the use of any additional tools. The patches are stored within the pouch in a plastic tray that has depressed areas designed to fit the pouch. Another tray rests above the storage tray allowing for the patch to maintain its moisture. The two trays are connected at two corners to maintain the integrity of the patch storage after manufacture and prior to use. Upon opening the tray the patches are positioned with the mesh side up. The hydrogel contains a plastic covering. The plastic covering must be removed prior to applying the patch to the appropriate area.

The area for application should be clean and dry prior to applying the patch. The hydrogel-mesh hybrid patch containing the composition is applied to the appropriate area. The patch should span the hairline and be covering both the skin and hair. The patch is attached to the hair/skin area in a manner that allows the hair/skin area to have contact with the hydrogel layer continuously while the patch is applied. Patch may remain on the affected area for as long as the user prefers. In one embodiment, the patch remains in place for at least 2 minutes, 5 minutes, at least 10 minutes, or at least 15 minutes. The patch remains on the area for at least 15 minutes while the active ingredients are absorbed by the skin and interact with the dermal and epidermal hair follicle area contained within the patch area.

Once to patch has remained in place for a proper amount of time, the patch may be removed and the remaining hydrogel and ingredients may be massaged into the hair and skin for additional benefit.

In one embodiment, the patch should be used continuously at least every other day, or four times a week, for about 10-20 minutes. Alternatively the patches may be applied every day for 10-20 minutes. Along with improving the appearance of hair growth the formula also contains ingredients that hydrates and moisturizes the dermal layer in the area of the patch. This decreases the appearance and feelings of skin irritation in the area the patch is applied including itching, redness, and general dryness.

This process should be repeated for at least 8-12 weeks for the best results. Following the initial 8-12 weeks, the patches may continue to be used for additional promotion and support of hair growth.

### Example 2: Targeted Delivery Hair Patches for Cosmetic Use

The hydrogel-mesh hybrid patch may also be used to apply a composition for sustained-release technology. The patch may be used to apply a composition for targeted delivery in a specific area for other cosmetic uses. Additional cosmetic uses for targeted delivery include absorption of vitamins and minerals for the strengthening of hair, targeted delivery of lotion and hydrating materials to areas with chronic hair dehydration.

A hydrogel-mesh hybrid patch that contains a composition that improves the appearance of hair but also includes vitamins and minerals that address issues unrelated to hair growth. These vitamins and minerals could include folate, vitamin A, vitamin C, vitamin D, vitamin E, vitamin B12, vitamin B6, magnesium, iron, calcium, biotin, niacin, riboflavin, thiamin, pantothenic acid, beta carotene, or other moisture and enrichment ingredients.

As the patch is applied and the hair absorbs the active components for hair strengthening, the skin could also absorb other needed supplemental vitamins and minerals at the same time.

### Example 3: Targeted Delivery Skin Patches for Cosmetic Use

The hydrogel-mesh hybrid patch may also be used to apply a composition for sustained-release technology for cosmetic benefit of the skin. The patch may be used to apply a composition for targeted delivery in a specific area for other cosmetic uses. Additional cosmetic uses for targeted delivery include absorption of vitamins and minerals for the strengthening of skin, targeted delivery of lotion and hydrating materials to areas with chronic skin dehydration.

A hydrogel-mesh hybrid patch that contains a composition that improves the appearance of hair but also includes vitamins and minerals that address issues unrelated to hair growth. These vitamins and minerals could include folate, vitamin A, vitamin C, vitamin D, vitamin E, vitamin B12, vitamin B6, magnesium, iron, calcium, biotin, niacin, riboflavin, thiamin, pantothenic acid, beta carotene, or other moisture and enrichment ingredients.

As the patch is applied and the skin absorbs the active components for the skin, the hair in the immediate area may also absorb other needed supplemental vitamins and minerals at the same time.

### Example 4: Patch for Targeted Delivery of Drug

The hydrogel-mesh hybrid patch may also be used as a targeted delivery for the sustained-release of a drug. The hydrogel mesh patch may contain active components to address targeted skin ailments and disorders experienced in isolated locations.

Disorders include acne, atopic dermatitis, epidermolysis bullosa, hidradenitis suppurativa, ichthyosis, pachyonychia congenital, pemphigus, psoriasis, rosacea, scleroderma, vitiligo, along with bug bites and stings.

The hydrogel layer could contain ingredients that provide local anesthetic for pain relief, anti-inflammatory agents for redness and itching relief. The patches could also provide protection from pain and irritation caused by external factors interacting with the affected area. The patches would also provide protection from further injury through infection.

### Example 5: Topical Solution Hair Growth Treatment

The composition could also be produced and used as a topical agent for targeting hair growth. The composition could take the form of a shampoo, conditioner, cream, ointment, oil, gel, foam, or an additive for any of the preceding. The composition could then be directly applied to the affected area and massaged into the scalp area and allowed to remain for a few minutes. The composition would then be able to absorb into the skin and hair area for targeted treatment. After 10-15 minutes the excess composition could be rinsed off. Alternately, the excess composition may be massaged into other adjacent areas for potential benefit.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. As such, the claims below shall be read to include all obvious variations and modifications that may be within the spirit of this invention.

### REFERENCES

1. Gohil, et al., Pharmacological Review on Centella asiatica: A Potential Herbal Cure-all, Indian Journal of Pharmaceutical Sciences, September-October 2010.
2. Manabe, et al., Guidelines for the Diagnosis and Treatment of Male-Pattern and Female-Pattern Hair Loss, 2017 Version, The Journal of Dermatology 2018(45): 1031-1043.
3. Ramos, et al., Female Pattern Hair Loss: A Clinical and Pathophysiological Review, An Bras Dermatol. 2015; 90(4):529-43.
4. Sun, et al., Therapeutic Potential of Centella asiatica and Its Triterpenes: A Review, Frontiers in Pharmacology 2020(11): 1-24.
5. Technical File: Capixyl™, Lucas Meyer Cosmetics, September 2017.
6. Truong et al., Red Ginseng (Panaz ginseng Meyer) oil: A comprehensive review of extraction technologies, chemical composition, health benefits, molecular mechanisms, and safety, Journal of Ginseng Research 2022(46): 214-224.

What is claimed is:

1. A composition for reducing the appearance of hair thinning, comprising:
a) an active ingredient that promotes hair stimulation;
b) an active ingredient that activates the hair follicle; and
c) an active ingredient for skin calming.

2. The composition of claim 1 wherein the active ingredient that promotes hair stimulation is further comprising
a synthetic compound wherein the synthetic compound is acetyl tetrapeptide-3; and
a natural plant extract, wherein the natural plant extract is trifolium pretense flower extract.

3. The composition of claim 1 wherein the active ingredient that activates the hair follicle is red ginseng.

4. The composition of claim 1 wherein the active ingredient for skin calming is Centella asiatica.

5. The composition of claim 1 further comprising 1-4% of acetyl tetrapeptide-3 and trifolium pretense flower extract, at least 1% red ginseng flower extract, and at least 1% Centella asiatica extract.

6. The composition of claim 1, further comprising a solvent selected from the group consisting of water, dipropylene glycol, 1, 2 hexanediol, propanediol, and combinations thereof.

7. The composition of claim 1, further comprising a humectant selected from the group consisting of butylene glycol, glycerin, and combinations thereof.

8. A patch delivery system comprising
a mesh substrate in a designed shape; and
a hydrogel layer comprising an active ingredient that promotes hair stimulation, an active ingredient that enhances hair strength, and an active ingredient for skin conditioning.

9. The patch delivery system of claim 8 wherein the designed shape is designed to fit an area selected from the group consisting of: a temple region of a face, a hairline in an anterior portion of a scalp, a hairline of the scalp, a balding spot, or an eyebrow.

10. The patch delivery system of claim 8 wherein the mesh substrate is a woven synthetic fiber with a mesh size between about 0.025 mm×0.025 mm to about 1 mm×1 mm.

11. The patch delivery system of claim 8 wherein the hydrogel layer further comprises:
a polyacrylate, wherein the polyacrylate comprises a range of 0.05-0.15% of the hydrogel;
a carrageenan, wherein the carrageenan comprises a range of 0.1-0.5% of the hydrogel; and
a carob gum, wherein the carob gum comprises a range of 0.3-0.6% of the hydrogel.

12. The patch delivery system of claim 8 wherein the active ingredient that promotes hair stimulation comprises acetyl tetrapeptide-3 and trifolium pretense flower extract.

13. The patch delivery system of claim 8 wherein the active ingredient that activates the hair follicle comprises red ginseng.

14. The patch delivery system of claim 8 wherein the active ingredient for skin calming comprises Centella asiatica extract.

15. A method of using a patch delivery system to increase the appearance of fuller-looking hair, comprising:
applying a patch to a targeted area of a scalp or face having thinning or reduced hair growth, wherein the patch comprises a hydrogel embedded around a mesh substrate;
waiting at least 5 minutes to allow time for the patch to deliver at least one active ingredient to hair follicles in the targeted area;
removing the patch from the targeted area.

16. The method of claim 15 wherein the targeted area is a temple.

17. The method of claim 15 wherein the targeted area is a hairline.

18. The method of claim 15 wherein the targeted area is a bald spot on the scalp.

19. The method of claim 15 wherein the targeted area is a hair part line on the scalp,

20. The method of claim 19 wherein the targeted area is an eyebrow.
